(19) United States
(12) Patent Application Publication
(10) Pub. No.: US 2007/0121453 A1
(43) Pub. Date: May 31, 2007

(54) Device for recording recordable media and method

(75) Inventor: Robert Alberta Arnoldus Ponsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,410

(22) PCT Filed: Nov. 4, 2004
(86) PCT No.: PCT/IB04/52304

§ 371 Date: May 15, 2006

(30) Foreign Application Priority Data
Nov. 18, 2003 (EP) 03104259.1

(51) Int. Cl. G11B 7/00

(52) U.S. Cl. 369/53.2; 369/30.21

(57) ABSTRACT

The invention relates to a device for recording recordable media, for example recordable DVD media types, a number of which is currently available in the market Upon receipt of a medium and assessment that the medium is a recordable medium, the device attempts to recognize it, i.e. to recognize its media type. If the recordable medium is not recognized, a reading operation is anyway performed. In this way it is left open the possibility to access recordable media belonging to a recordable media type unknown to the device but from which the device can nevertheless read, e.g. a newly introduced media type belonging to a media family known to the device. If applied to a device for recoding DVD, the invention makes it possible to read from a DVD+R9 medium. The invention further relates to a method for accessing a medium.

The invention relates to a device for recording recordable media and a method for accessing a medium.

An embodiment of a device of the type indicated above is a DVD recorder such as the ones currently available in the market, like for example the model DVDR75 of Philips, which is a DVD+RW recorder.

At present time media belonging toe a plurality of recordable DVD media types, also known as “formats”, are available in the market: DVD−R, DVD−RW, DVD+R, DVD+RW, all belonging to the DVD media family, i.e. media that when recorded and, finalized can be read by a DVD−ROM player. A recordable DVD medium is said to be finalized when a definitive table indicating the content of the medium has been recorded on the medium at a fixed location, as according to the DVD−ROM standard.

This known DVD recorder is capable of recording on media belonging to the recordable DVD media types DVD+R and DVD+RW, and of reading media belonging to other recordable DVD media types: DVDR and DVD−RW. Similarly, other DVD recorders currently available in the market are able, among other things, to record on media belonging to some recordable DVD media types, and of reading media belonging to other recordable DVD media types.

There are several reasons why a DVD recorder supports a possibly different set of access functionalities for different media types. A first reason is that accessing a medium is done in a way dependent on the media type to which the medium belongs, and therefore requires ad hoc software modules, and sometimes imposes different hardware features, so that the DVD recorder is simply not capable, due to software/hardware constraints, of accessing some media types.

A second reason is that some of the formats are competitive among them and therefore a DVD recorder producer may decide to design a DVD recorder so as to privilege some formats by supporting them and to penalize other formats by not supporting them. Therefore the DVD recorder is designed to selectively enable for a medium of a recordable DVD media type a set of access functionalities, including all, some or none of record, read non-finalized and read finalized, according to the recordable DVD media type. The access functionalities of a DVD recorder thus reflect both its hardware and software limitations, as well as its intended use.

To this end a DVD recorder, upon receipt of a medium, initially performs a discrimination step to assess if the medium is a recordable medium; then, if the medium is indeed a recordable medium, performs a recognition step during which it attempts to recognize the recordable media type to which the medium belongs, and consequently enables the set of supported access functionalities for that recordable media type.

It is a disadvantage that the known DVD recorder can access only media types for which a set of functionalities is enabled, based on the recognition of the media type.

It is a first object of the present invention to provide a device for recording recordable media having additional access functionalities. It is a second object of the present invention to provide a method for accessing a medium which can be applied in a device for recording recordable media in order that the device acquires additional access functionalities.

The first object according to the invention is realized by the device having the features of claim 1.

The invention is based on the recognition that a DVD recorder like the ones currently available in the market can only recognize media types which are known to it, and which are therefore known at the time when the DVD recorder has been designed. However, since new media types, and in particular new recordable DVD media types, are from time to time introduced into the market, a recordable medium belonging to a newly introduced recordable DVD media type cannot be recognized, and therefore after failure of the recognition step is not further handled, regardless of the fact that user-information, e.g. music, a movie, software or other user-data, present on the recordable medium might be readable, and could be read if there was an instruction to do so.

The device according to the invention instead remedies this limitation, due to the presence of the user-information recovery unit, which instructs the reading unit to read user-information present on the recordable medium. Thus the device is able to read user-information present on an unrecognized recordable medium, e.g. a medium belonging to a media type which could not have been known at the time when the device was designed, provided that the user-information is in a format known to the device producer at the time when the device was produced and designed. If the device is a device for recording DVD, this would be the case for upcoming formats belonging to the DVD media family, like for example the dual layer recordable DVD based on DVD+R, DVD+R9. Therefore the device according to the invention has enhanced additional functionalities.

The table of recordable media types may comprise recordable DVD media types; more in particular the table may comprise the following media types: DVD+R, DVD−R, DVD+RW, and DVD−RW, all belonging to the DVD media family. However the table may also comprise CD recordable media types and/or Blue-ray Disk (BD), or a combination of media types belonging to different media families, CD, DVD and BD.

According to the invention the second object is achieved by the method having the features of claim 4. The presence of the reading step upon failure of the recognition step makes it possible to read user-information present on an unrecognized recordable medium, provided that the user-information is in a format known to the device. In case the method is applied in a device for recording DVD, the method would make it possible to read a medium belonging to the DVD+R9 media type, in case a medium of such a media type is not recognized, therefore causing the device for recording DVD to acquire additional access functionalities.

These and other aspects of the device and method according to the invention will be further elucidated and described with reference to the drawings. In the drawings:

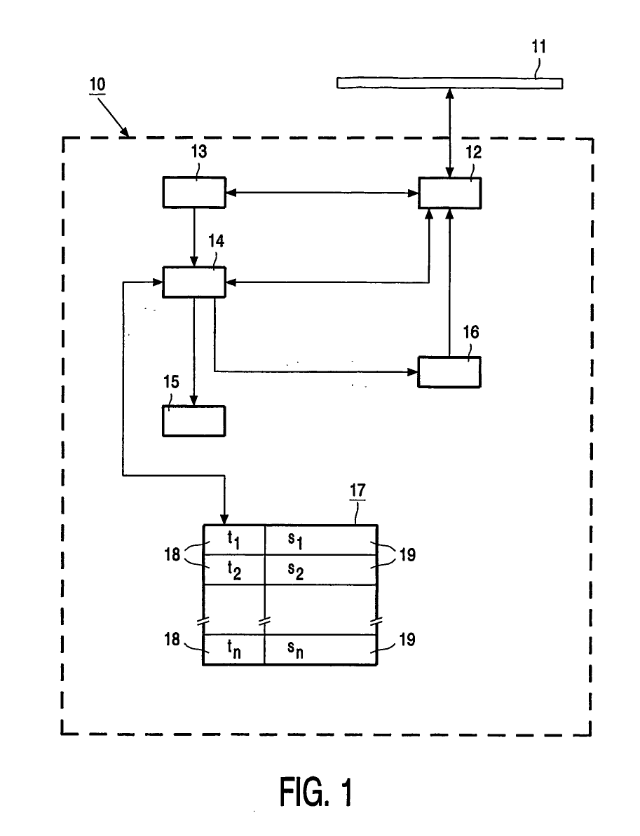

FIG. 1 shows an embodiment of the device according to the invention,

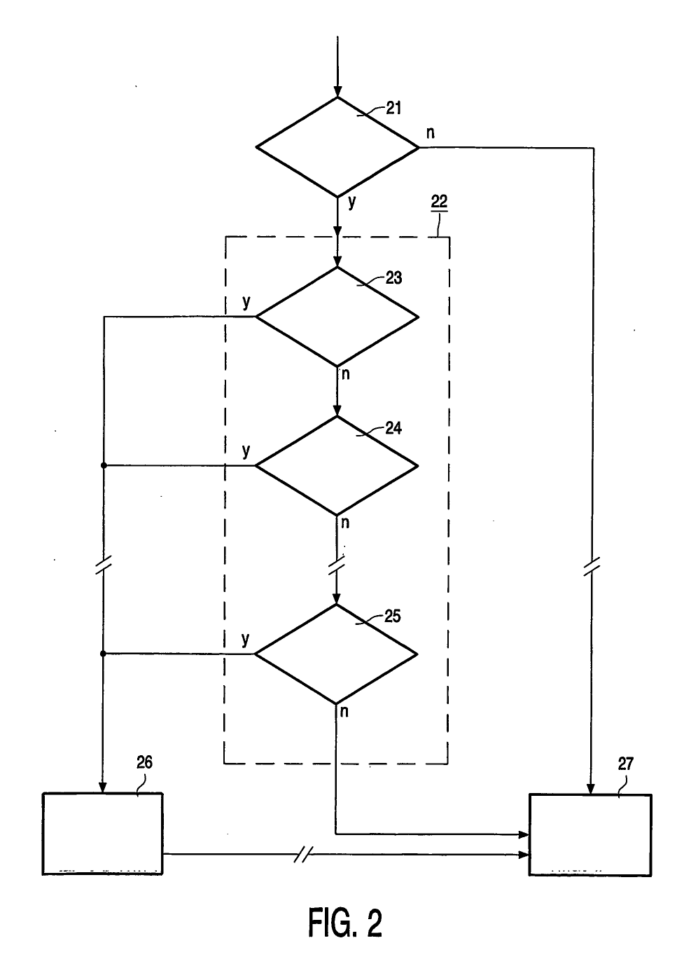

FIG. 2 shows an embodiment of the method according to the invention.

FIG. 1 shows an embodiment of the device according to the invention.

The device 10 comprises a reading unit 12 for acquiring information present on a medium 11, a discrimination unit 13 for assessing if the medium 11 is a recordable medium, a table 17 of recordable media types 18 having a set of supported access functionalities 19 for each recordable media type, a recognition unit 14 for recognizing, in case the discrimination unit 13 has assessed that the medium 11 is a recordable medium, the recordable media type to which the recordable medium belongs, an enabling unit 15 for enabling the relevant set of supported functionalities 19 in case the recognition unit 14 succeeds in recognizing the recordable media type to which the recordable medium belongs, and a user-information recovery unit 16 for instructing the reading unit 12 to read the user-information present on the recordable medium in case the recognition unit 14 fails.

The reading unit 12 may comprise read-out means to generate signals carrying the information present on the medium 11, like for example a laser or head, as well as circuitry and software code to retrieve the information from these signals.

The discrimination unit 13 may operate by assessing if the medium possesses a distinctive feature indicative of whether the medium 11 is a recordable medium. In case for example the medium 11 is a DVD, but the same can be said for other optical disks, this distinctive feature is a radial modulation of a spiral track present on the disk, also known as wobble, which is present on a recordable DVD but not on a DVD−ROM, and from which a corresponding wobble signal can be generated. Therefore on a device for recording DVD the discrimination unit 13 comprises circuitry to reveal the presence of the wobble signal and software code to interrogate such circuitry.

The recognition unit 14 operates on the basis of the table 17 of recordable media types 18.

The recordable medium may comprise a format information, indicative of the recordable media type 18 to which it belongs. In this case a copy of the format information characteristic of each recordable media type 18 present in the table 17 may be stored in a memory present in the device 10. Therefore the recognition unit 14 may operate by retrieving from the recordable medium the format information, and consequently comparing such format information with the format information characteristic of a recordable media type 18 present in the table 17, until a recordable media type 18 present in the table 17 is matched, in which case the recordable medium is recognized, i.e. the recognition unit 14 has succeeded, or all the recordable media types 18 present in the table 17 have been checked without any matching having occurred, in which case the recordable medium is not recognized, i.e. the recognition unit 14 has failed. In the case of a recordable DVD, the format information can be derived from an ADIP frame. However, in alternative or in combination to the method described above, the recognition unit 14 may operate by analyzing in various ways the signals generated by the read-out means and comparing distinctive features of these signals with the corresponding features for known media types.

The recognition unit 14 may comprise both circuitry and software code. In this context the recognition unit 14 is only responsible for the recognition of a recordable medium. Other units to identify the features of the medium 11, like for example single/dual layer, 8/12 cm diameter, CD/DVD, may be present in the device and intervene at some stage before an access can take place.

In case the recognition unit 14 succeeds in recognizing the recordable media type 18 to which the recordable medium 11 belongs, the enabling unit 15 intervenes to enable the set of supported functionalities 19 for the recordable media type 18 to which the recordable medium belongs. The enabled functionalities can then be activated upon request of a user and/or of an application program. Preferably the enabling unit 15 is implemented in the form of software code.

In case the recognition unit 14 fails in recognizing the recordable media type to which the recordable medium belongs, the user-information recovery unit 16 intervenes to instruct the reading unit 12 to read user-information present on the recordable medium. It is possible that user-information is present on the recordable medium and that this user-information can be read, in spite the recordable medium is not recognized by the device 10, at least in the case that the recordable medium has been finalized.

It has to be outlined that the user-information recovery unit 16 and the recognition unit 14 may be integral; furthermore they may be integral with the enabling unit 15.

The presence of such user-information recovery unit is 16 a particularly useful feature if applied to a device for recording recordable media belonging to a media family wherein new recordable media types emerge from time to time and are likely to emerge in the future, like for example the DVD media family.

The table 17 comprises a list of recordable media types 18, i.e. the recordable media types 18 known to the device 10, and a set of supported access functionalities 19 for each recordable media type 18. The access functionalities are: record, read non-finalized, read finalized. A recordable DVD medium is said to be finalized when a definitive table indicating the content of the medium has been recorded on the medium at a fixed location, as according to the DVD−ROM standard.

For a set of supported access functionalities 19 specified for a recordable media type 18 the following main possibilities exist:

all access functionalities are present, in which case full support is given for the recordable media type 18,

no access functionalities are present, in which case no support is given for the recordable media type 18,
only the read finalized access functionality is present, in which case read-only support is given for the recordable media type 18.

Although not likely, it is in principle possible that for the recordable media type 18 both read non-finalized and read finalized are present in the set of supported access functionalities 19.

Such a table 17 can be stored in a memory present in the device 10, in the form of an array or a list of records, or in any other suitable form. However, it is possible that the method with which the device 10 accesses a medium 11, as for the steps of recognizing the type of medium 11 and the functionalities to be consequently enabled, reflects implicitly the indications of a such table 17, even without the table 17 being physically stored in a memory present in the device 10. In this case the presence of a such table 17, which effectively indicates what access functionalities have to be enabled for each known media type, is implied.

FIG. 2 shows an embodiment of the method for accessing a medium according to the invention. The method consists of a discrimination step 21, a recognition step 22, an enabling step 26, and a reading step 27.

In the discrimination step 21 it is assessed if the medium 11 is a recordable medium. If yes, the recognition step 22 takes place for recognizing, on the basis of a table 17 of recordable media types 18 having a set of supported access functionalities 19 for each recordable media type 18, the recordable media type 18 to which the recordable medium belongs.

The recordable medium may comprise a format information, indicative of the recordable media type 18 to which it belongs. The recognition step 22 may consist of sub-steps 23-25, in which therefore the format information retrieved from the recordable medium is compared with the format information characteristic of a recordable media type 18 present in the table 17. In particular, in a first sub-step 23 the format information of the recordable medium is compared to the format information of the recordable media type t1: if there is a match then the recordable medium is successfully recognized as belonging to the media type t1, otherwise the method continues with the next step.

The sub-steps 24 and 25 are performed in a similar manner, until a recordable media type 18 present in the table 17 is matched, in which case the recordable medium is successfully recognized, or all the recordable media types 18 present in the table 17 have been checked without any matching having occurred, in which case the recordable medium is not recognized, i.e. the recognition step fails.

In the case of a recordable DVD, the format information can be derived from an ADIP frame. However, in alternative or in combination to the method described above, the recognition unit 14 may operate by analyzing in various ways the signals generated by the read-out means and comparing distinctive features of these signals with the corresponding features for known media types.

If the recognition step succeeds, in the enabling step 26 the set of supported access functionalities 19 for the recordable media type 18 to which the recordable medium belongs is enabled. If the recognition step 22 fails, the reading step 27 takes place for reading the user-information present on the recordable medium. The reading step 27 may be the same as the step performed if the discrimination step 21 assessed if the medium 11 is not a recordable medium. Moreover the reading step 27 may be also the same as a reading step following the enabling step 26 performed upon request by a user or by an application program.

Although the invention has been elucidated with reference to a device for recording optical disks, and in particular DVD, and a corresponding method for accessing, it will be evident that other embodiments may be alternatively used to achieve the same object. The scope of the invention is therefore not limited to the embodiments described above, but can also be applied to other kinds of information carriers or to the transmission of information.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. The invention relates to a device for recording recordable media, for example recordable DVD media types, a number of which is currently available in the market. Upon receipt of a medium and assessment that the medium is a recordable medium, the device attempts to recognize it, i.e. to recognize its media type. If the recordable medium is not recognized, a reading operation is anyway performed. In this way it is left open the possibility to access recordable media belonging to a recordable media type unknown to the device but from which the device can nevertheless read, e.g. a newly introduced media type belonging to a media family known to the device. If applied to a device for recoding DVD, the invention makes it possible to read from a DVD+R9 medium.

The invention further relates to a method for accessing a medium.

1. A device (10) for recording recordable media belonging to at least one recordable media type, comprising:
a discrimination unit (13) for assessing, upon receipt of a medium (11), if the medium is a recordable medium,
a reading unit (12) for reading user-information present on the medium,
a table (17) of recordable media types (18), the table having a set of supported access functionalities (19) for each recordable media type,
a recognition unit (14) for recognizing, when the discrimination unit has assessed that the medium is a recordable medium, the recordable media type to which the recordable medium belongs,
an enabling unit (15) for enabling the set of supported access functionalities for the recordable media type to which the recordable medium belongs, and
a user-information recovery unit (17) for instructing the reading unit to read the user-information present on the recordable medium, upon failure of the recognition unit to recognize the recordable media type present in the table to which the recordable medium belongs.

2. A device (10) as claimed in claim 1, wherein the table (17) comprises recordable DVD media types.

3. A device (10) as claimed in claim 2, wherein the table (17) comprises in particular: DVD+R, DVD−R, DVD+RW, and DVD−RW.

4. A method for accessing a medium (11) comprising:
a discrimination step (21) for assessing if the medium is a recordable medium,
if the discrimination step has assessed that the medium is a recordable medium, a recognition step (22), based on a table of recordable media types, the table having a set of supported access functionalities referred to each recordable media type, for recognizing the recordable media type to which the recordable medium belongs,
if the recognition step has succeeded in recognizing the recordable media type to which the recordable medium belongs, an enabling step (26) for enabling the set of supported access functionalities for the recordable media type to which the recordable medium belongs, and
if the recognition step has failed to recognize the recordable media type to which the recordable medium belongs, a reading step (27) for reading the user-information present on the recordable medium.
